(19) United States
(12) Patent Application Publication
(10) Pub. No.: US 2026/0126876 A1
(43) Pub. Date: May 7, 2026

(54) TOUCH-SENSITIVE APPARATUS AND METHOD

(71) Applicant: TouchNetix Limited, Fareham, Hampshire (GB)

(72) Inventor: Stephen William ROBERTS, Fareham, Hampshire (GB)

(73) Assignee: TouchNetix Limited, Fareham, Hampshire (GB)

(21) Appl. No.: 19/118,216

(22) PCT Filed: Oct. 17, 2023
(86) PCT No.: PCT/GB2023/052686

§ 371 Date: Apr. 3, 2025

(30) Foreign Application Priority Data
Oct. 19, 2022 (GB) 2215439.7

(51) Int. Cl. G06F 3/041; G06F 3/044

(52) U.S. Cl. CPC G06F 3/0418; G06F 3/0446; G06F 2203/04111

(57) ABSTRACT

Disclosed is a touch-sensitive apparatus, the apparatus including an electrode array, comprising at least a drive electrode; drive circuitry configured to generate one or more drive signals comprising at least a first drive signal for driving the at least a drive electrode; and control circuitry. The control circuitry is configured to: identify a set of N drive electrodes comprising the at least a drive electrode; apply the one or more drive signals to the set of N drive electrodes, wherein the control circuitry is configured to apply the one or more drive signals in a plurality of discrete time periods; obtain a measurement from the electrode array in each of the plurality of discrete time periods; determine an indication of a capacitive coupling associated with the at least a drive electrode; and determine an indication of the noise for the set of N drive electrodes.

### BACKGROUND OF THE INVENTION

The present invention relates to the field of touch sensors, for example touch sensors for overlying a display screen to provide a touch-sensitive display (touch screen). In particular, embodiments of the invention relate to techniques for measuring the mutual capacitance at a plurality of intersections between drive electrodes and receive electrodes for sensing the presence of one or more touching objects within a two-dimensional sensing area.

A capacitive touch sensor can be generalised as one that uses a physical sensor element comprising an arrangement of electrically conductive electrodes extending over a touch sensitive area (sensing area) to define sensor nodes (or intersection points) and controller circuitry connected to the electrodes and operable to measure changes in the electrical capacitance of each of the electrodes or the mutual-capacitance between combinations of the electrodes. The electrodes are typically provided on a substrate. Some of these electrodes may be referred to as drive electrodes (which are driven with a suitable signal, such as a time-varying voltage signal) and some may be referred to as receive electrodes (which are coupled to receiver circuitry and generate a signal in response to a driven drive electrode coupling to the receiver electrode at the sensor node).

For capacitive touch sensors in which the mutual capacitance is measured between combinations of electrodes, to perform a complete scan of the mutual capacitance over the touch sensitive surface, each sensor node or intersection point for the electrodes must be individually measured. This may be done by driving each drive electrode individually and sequentially with a suitable signal and measuring the signal generated in each receiver electrode that forms an intersection point with that drive electrode.

The performance of touch sensors may be characterised in accordance with at least two characteristics; namely the sensitivity of the touch sensor (i.e., how easily the touch sensor can detect a touch) and the responsiveness of the touch sensor (i.e., how quickly the touch sensor can detect/register a touch on the sensing surface from the moment a touch is present). In mutual capacitance measurement techniques, the sensitivity is broadly proportional to the time taken to measure the mutual capacitance at each intersection point between combinations of electrodes (or more particularly, on the number of samples of the mutual capacitance for each intersection point that can be taken in that time period)—generally, the greater the measurement time period, the better the sensitivity. Conversely, the responsiveness is broadly proportional to the total time required to measure the mutual capacitance at all the intersection points of an electrode array-generally, the shorter the time period, the better the responsiveness.

Most applications for touch sensors require both good sensitivity and good responsiveness, but as evident from above, a balance must be struck between the two parameters. One way to help improve the sensitivity and/or responsiveness is to employ faster electronics which can sample a signal (the mutual capacitance) at a higher sample rate. However, faster electronics are usually expensive and may be relatively large, and are thus are not practical for all commercial applications.

Additionally, such capacitive touch sensors can be subject to noise (e.g., from sources external to the capacitive touch sensor). By measuring the capacitive coupling in the absence of any drive signal applied to the electrodes, an indication of the noise that the (or parts of the) electrode array is exposed to can be determined. This determined noise can subsequently be used to determine to what extent the capacitive coupling at a particular node/intersection point was influenced by noise, and thus the relative confidence in each of the measurements. Because such a measure of the noise requires that the electrodes are not driven by a drive signal, measurement of the noise may occur after each complete scan of the electrode array. That is to say, the capacitive touch sensor may be operated on a time division basis in which the capacitive touch sensor is operated in one of two frames—a measurement frame in which the capacitive touch sensor is configured to provide signals for each of the intersection points of the electrode array as described above, and a noise frame in which the capacitive touch sensor is configured to provide signals indicative of the noise of the electrode array. Operating in this way has an impact on the responsiveness of a touch sensor. For instance, the additional time required for the noise frame increases the time between measurement frames. While the capacitive touch sensor may not necessarily operate according to a noise frame between each measurement frame (for example the noise frame may be performed after every one, two, three, etc. measurement frames), the inclusion of a noise frame nonetheless reduces the responsiveness of the capacitive touch sensor.

There is therefore a desire to provide touch sensors which can offer an improvement in responsiveness and/or sensitivity in detecting touches.

### SUMMARY OF THE INVENTION

According to a first aspect of the invention there is provided a touch-sensitive apparatus, the apparatus including: an electrode array, comprising at least a drive electrode; drive circuitry configured to generate one or more drive signals comprising at least a first drive signal for driving the at least a drive electrode; control circuitry configured to: identify a set of N drive electrodes comprising the at least a drive electrode, where N is an integer greater than or equal to one; apply the one or more drive signals to the set of N drive electrodes, wherein the control circuitry is configured to apply the one or more drive signals in a plurality of discrete time periods, wherein the number of electrodes in the set of N drive electrodes is less than the number of discrete time periods; obtain a measurement from the electrode array in each of the plurality of discrete time periods; determine an indication of a capacitive coupling associated with the at least a drive electrode based on the obtained measurements from the electrode array in each of the plurality of discrete time periods; and determine an indication of the noise for the set of N drive electrodes based on the obtained measurements from the electrode array in each of the plurality of discrete time periods.

According to a second aspect of the invention there is provided a system comprising the touch-sensitive apparatus of the first aspect, further comprising system processing circuitry communicatively coupled to the processing circuitry of the touch-sensitive apparatus.

According to a third aspect of the invention there is provided a method for enabling the presence of a touch on or in the vicinity of a touch-sensitive element of a touch-sensitive apparatus to be determined, the touch-sensitive apparatus comprising an electrode array, comprising at least a drive electrode, drive circuitry configured to generate one or more drive signals comprising at least a first drive signal for driving the at least a drive electrode, and control circuitry, wherein the method includes: identifying a set of N drive electrodes comprising the at least a drive electrode; applying the one or more drive signals to the set of N drive electrodes in a plurality of discrete time periods, wherein the number of electrodes in the set of N drive electrodes is less than the number of discrete time periods; obtaining a measurement from the electrode array in each of the plurality of discrete time periods;

determining an indication of a capacitive coupling associated with the at least a drive electrode based on the obtained measurements from the electrode array in each of the plurality of discrete time periods; and determining an indication of the noise for the set of N drive electrodes based on the obtained measurements from the electrode array in each of the plurality of discrete time periods.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

The invention is now described by way of example only with reference to the following drawings in which:

FIG. 1 schematically illustrates a touch sensitive apparatus in accordance with certain embodiments of the invention;

FIG. 2 schematically illustrates the mutual-capacitance type a touch sensitive apparatus of FIG. 1 in more detail, specifically with a view to explaining the principles of mutual capacitance measurement;

FIG. 3 schematically illustrates a conventional mutual-capacitance type touchscreen apparatus for explaining the measurement steps associated with a conventional mutual-capacitance type touchscreen;

FIG. 4 schematically illustrates the drive circuitry of the touch sensitive apparatus of FIG. 1 in more detail in accordance with certain embodiments of the invention;

FIGS. 5a to 5d schematically illustrates a part of an electrode array of a touch sensitive apparatus for explaining known measurement techniques utilising a plurality of drive signals;

FIGS. 6a to 6d schematically illustrates a part of an electrode array of a touch sensitive apparatus for explaining measurement techniques utilising a plurality of drive signals and for obtaining a noise measurement in accordance with certain embodiments of the invention;

FIG. 7 schematically illustrates an example system which employs the touch sensitive apparatus of FIG. 1 in accordance with certain embodiments of the invention; and

FIG. 8 shows a method for detecting a touch using a touch sensitive apparatus in accordance with certain embodiments of the invention.

### DETAILED DESCRIPTION

Broadly speaking, the present invention relates to a mutual capacitance type touch sensitive apparatus which uses a mutual capacitance measurement technique to measure (directly or indirectly) the mutual capacitances at intersections between drive or transmit electrodes and receive electrodes of an electrode array forming a touch sensitive element. More specifically, the present invention applies combinations of a drive signals to a set of drive electrodes of the electrode array and measures the resulting signal at the receive electrode which capacitively couples thereto. More specifically, different combinations of the drive signals are applied at different times (or for different time durations) and measurements for each of the respective time periods are obtained. The number of measurements (and thus the number of time periods) is greater than the number of drive electrodes in the set of drive electrodes. By applying different combinations of the drive signals to the set of electrodes at different time periods, and making measurements of the resultant signals, the touch sensitive apparatus can obtain data relating to the mutual capacitance at each of the intersection points simultaneously. Moreover, because an additional measurement is obtained, it is possible to derive an indication of the noise that affects these mutual capacitance measurements. In other words, using all of the obtained measurements the circuitry is able to calculate firstly a value indicative of the mutual capacitance at the intersection point(s) and secondly (using the same measurements) is able to calculate a value indicative of the noise that the set of electrodes/receive electrode experiences. Such an approach offers advantages of improved sensitivity and/or responsiveness of the touch sensitive apparatus and is capable of providing a more accurate measure of the noise that affects the set of drive electrodes.

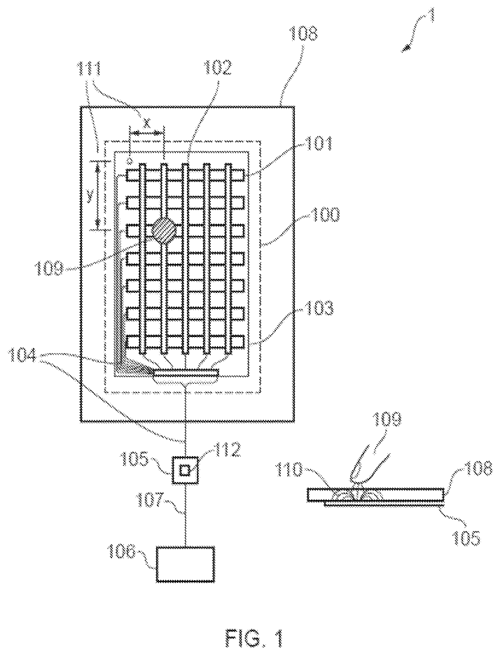

FIG. 1 schematically shows a touch-sensitive apparatus 1 in accordance with the principals of the present disclosure. The touch-sensitive apparatus 1 is represented in plan view (to the left in the figure) and also in cross-sectional view (to the right in the figure).

The touch-sensitive apparatus 1 comprises a sensor element 100, measurement circuitry 105, processing circuitry 106, and cover 108. The sensor element 100 and cover 108 may, more generally be referred to as a touch screen or touch-sensitive element of the touch-sensitive apparatus 1, while the measurement circuitry 105 and processing circuitry 106 may, more generally, be referred to as the controller of the touch-sensitive apparatus 1.

The touch screen is primarily configured for establishing the position of a touch within a two-dimensional sensing area by providing Cartesian coordinates along an X-direction (horizontal in the figure) and a Y-direction (vertical in the figure). In this implementation, the sensor element 100 is constructed from a substrate 103 that could be glass or plastic or some other insulating material and upon which is arranged an array of electrodes consisting of multiple laterally extending parallel electrodes, X-electrodes 101 (row electrodes), and multiple vertically extending parallel electrodes, Y-electrodes 102 (column electrodes), which in combination allow the position of a touch 109 to be determined. To clarify the terminology, and as will be seen from FIG. 1, the X-electrodes 101 (row electrodes) are aligned parallel to the X-direction and the Y-electrodes 102 (column electrodes) are aligned parallel to the Y-direction. Thus the different X-electrodes allow the position of a touch to be determined at different positions along the Y-direction while the different Y-electrodes allow the position of a touch to be determined at different positions along the X-direction. That is to say in accordance with the terminology used herein, the electrodes are named (in terms of X- and Y-) after their direction of extent rather than the direction along which they resolve position. Furthermore, the electrodes may also be referred to as row electrodes and column electrodes. It will however be appreciated these terms are simply used as a convenient way of distinguishing the groups of electrodes extending in the different directions. In particular, the terms are not intended to indicate any specific electrode orientation. In general the term “row” will be used to refer to electrodes extending in a horizontal direction for the orientations represented in the figures while the terms “column” will be used to refer to electrodes extending in a vertical direction in the orientations represented in the figures. The X-electrodes 101 and Y-electrodes 102 define a sensing (or sense) area, which is a region of the substrate 103 which is sensitive to touch.

In some cases, each electrode may have a more detailed structure than the simple “bar” structures represented in FIG. 1, but the operating principles are broadly the same. The sensor electrodes are made of an electrically conductive material such as copper or Indium Tin Oxide (ITO). The nature of the various materials used depends on the desired characteristics of the touch screen. For example, a touch screen may need to be transparent, in which case ITO electrodes and a plastic substrate are common. On the other hand a touch pad, such as often provided as an alternative to a mouse in laptop computers is usually opaque, and hence can use lower cost copper electrodes and an epoxy-glass-fibre substrate (e.g. FR4).

Referring back to FIG. 1, the electrodes 101, 102 are electrically connected via circuit conductors 104 to measurement circuitry 105, which is in turn connected to processing circuitry 106 by means of circuit conductors 107. The measurement circuitry 105 and/or the processing circuitry 106 may each be provided by a (micro) controller, processor, ASIC or similar form of control chip. Although shown separately in FIG. 1, in some implementations, the measurement circuitry and the processing circuitry may be provided by the same (micro) controller, processor, ASIC or similar form of control chip. The measurement circuitry 105 and/or the processing circuitry 106 may be comprised of a printed circuit board (PCB), which may further include the various circuit conductors 104, 107. The measurement circuitry 105 and the processing circuitry 106 may be formed on the same PCB, or separate PCBs. Note also that the functionality provided by either of the measurement circuitry 105 and the processing circuitry 106 may be split across multiple circuit boards and/or across components which are not mounted to a PCB. The processing circuitry 106 interrogates the measurement circuitry 105 to recover the presence and coordinates of any touch or touches present on, or proximate to, the sensor element 100.

Generally speaking, the measurement circuitry 105 is configured to perform capacitance measurements associated with the electrodes 101, 102 (described in more detail below). The measurement circuitry 105 comprises drive circuitry 112 for generating electrical signals for performing the capacitance measurements. The measurement circuitry 105 outputs the capacitance measurements to the processing circuitry 106, which is arranged to perform processing using the capacitance measurements. The processing circuitry 106 may be configured to perform a number of functions, but at the very least is configured to determine when a touch 109, caused by an object such a human finger or a stylus coming into contact with (or being adjacent to) the sense area of the sensor element 100 with appropriate analysis of relative changes in the electrodes' measured capacitance/capacitive coupling. This determination process is described in more detail below. The processing circuitry 106, as in the described implementation, may also be configured to, with appropriate analysis of relative changes in the electrodes' measured capacitance/capacitive coupling, calculate a touch position on the cover's surface as an X-Y coordinate 111.

In the example, a front cover (also referred to as a lens or panel) 108 is positioned in front of the substrate 103 and a single touch 109 on the surface of the cover 108 is schematically represented. Note that the touch itself does not generally make direct galvanic connection to the sensor 103 or to the electrodes 102. Rather, the touch influences the electric fields 110 that the measurement circuitry 105 generates using the electrodes 102 (described in more detail below).

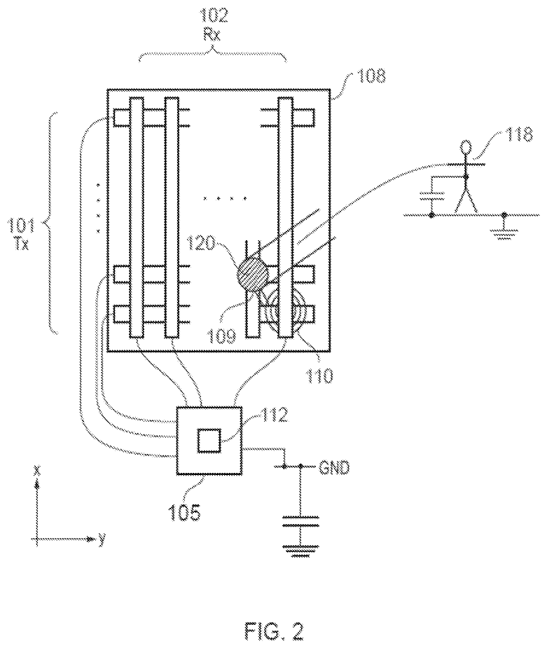

The measurement circuitry 105 of the described implementation is configured to measure the capacitance of the electrodes using a technique that is based on measuring what is frequently referred to as “mutual-capacitance”. Reference is made to FIG. 2. In FIG. 2, the drive circuitry 112 of the measurement circuitry 105 is configured to generate and apply an electrical stimulus (drive signal) 113 to sequentially stimulate each of an array of transmitter (driven/drive) electrodes, shown as the X electrodes 101 in FIG. 2, that are coupled by virtue of their proximity to an array of receiver electrodes, shown as the Y electrodes 102 in FIG. 2. (It should be appreciated that the Y electrodes 102 may instead be the transmitting electrodes and the X electrodes 101 may instead be the receiving electrodes in other implementations). The resulting electric field 110 is now directly coupled from the transmitter to each of the nearby receiver electrodes. This is in contrast to systems which employ a technique that measure the “self-capacitance” of an electrode. The area local to and centred on the intersection of a transmitter and a receiver electrode is typically referred to as a “node” or “intersection point”. Now, on application or approach of a conductive element such as a human finger, the electric field 110 is partly diverted to the touching object. That is, some of the field couples via the finger through the connected body 118, through free space and back to the measurement circuitry 105. An extra return path to the measurement circuitry 105 is hence established via the body 118 and “free-space”. However, because this extra return path acts to couple the diverted field directly to the measurement circuitry 105, the amount of field coupled to the nearby receiver electrode 102 decreases. This is measured by the measurement circuitry 105 as a decrease in the “mutual-capacitance” between that particular transmitter electrode and receiver electrodes in the vicinity of the touch 109. The measurement circuitry 105 senses this change in capacitance of one or more nodes. For example, if a reduction in capacitive coupling to a given Y-electrode is observed while a given X-electrode is being driven, it may be determined there is a touch in the vicinity of where the given X-electrode and given Y-electrode cross, or intersect, within the sensing area of the sensor element 100. The magnitude of a capacitance change is nominally proportional to the area 120 of the touch (although the change in capacitance does tend to saturate as the touch area increases beyond a certain size to completely cover the nodes directly under the touch) and weakly proportional to the size of the touching body (for reasons as described above). The magnitude of the capacitance change also reduces as the distance between the touch sensor electrodes and the touching object increases.

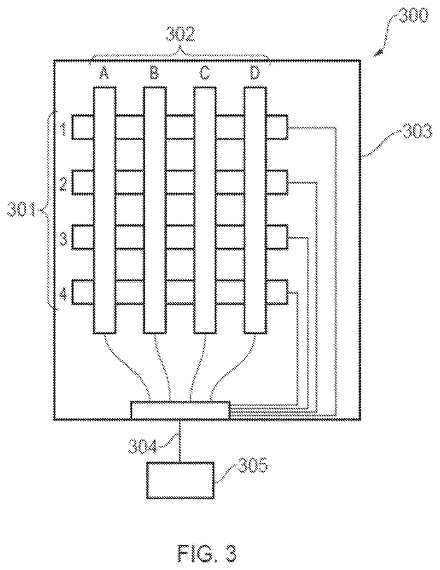

In the described implementation, the electrodes 101, 102 are arranged on an orthogonal grid, with a first set of electrodes (e.g., the transmitter electrodes 101) on one side of a substantially insulating substrate 103 and the other set of electrodes (e.g., the receive electrodes 102) on the opposite side of the substrate 103 and oriented at substantially 90° to the first set. This is also as schematically shown in FIG. 3. In other implementations, the electrodes may be oriented at a different angle (e.g., 30°, 40°, etc.) relative to one another. In addition, it should also be appreciated that it is also possible to provide structures where the grid of electrodes is formed on a single side of the substrate 103 and small conductive bridges are used to allow the two orthogonal sets of electrodes to cross each other without short circuiting. However, these designs are more complex to manufacture and less suitable for transparent sensors. Regardless of the arrangement of the electrodes, broadly speaking, one set of electrodes is used to sense touch position in a first axis that we shall call “X” and the second set to sense the touch position in the second orthogonal axis that we shall call “Y”.

The mutual capacitance measurement technique offers some advantages over other techniques, such as self-capacitance measurement techniques, in that mutual capacitance measurement techniques can identify mutual capacitance changes independently at each of the electrode intersection points. This means that the mutual capacitance technique lends itself to applications which require the detection of multiple touches as inputs to associated apparatuses (such as a PC or other computing device running a software application). However, the mutual capacitance technique is generally not as sensitive to touches as other techniques such as self-capacitance measurement techniques, partly due to the fact that sources of noise have a much more significant impact on the signals received using the mutual capacitance measurement technique. What this means is that it may be more difficult when using mutual capacitance measurement techniques to correctly identify a touch as genuine (i.e., resulting from a user touching the touch sensitive element) as opposed to a source of noise. In order to increase the sensitivity, a greater sample time is required for sampling the signal (i.e., the measured mutual capacitance). This provides a greater signal to noise ratio. However, increasing the sample time to increase the ability of the touch sensor to sense a genuine touch (i.e., improve sensitivity) generally increases the response time of the system (i.e., how quickly the touch-sensitive apparatus responds (outputs an indication that a touch is detected) when an object is first placed on the touch-sensitive present). A balancing of these two considerations is a part of what drives the design of mutual capacitance measurement based touch sensors.

It may also be beneficial to understand the noise, particularly external noise, that influences the measurements on the touch-sensitive apparatus. External noise is often difficult to predict and hence reliably compensate for. Having an indication of the level of noise that affects a particular obtained measurement or obtained set of measurements can be used to ascertain a level of confidence in the obtained measurement(s). For example, the stronger the noise (i.e., the greater the magnitude of the noise) when obtaining a measurement, the lower the confidence that the obtained measurement results from a genuine object sensed by the touch-sensitive apparatus as opposed to any external noise. Hence, an indication of noise can be used to “filter” obtained measurements based on a low confidence associated with those measurements. However, attempts to obtain an indication of noise using conventional techniques are not ideal for a variety of reasons (explained in more detail below), such as leading to a decrease in the responsiveness of the touch-sensitive apparatus as the process of obtaining an indication of the noise requires additional time.

FIG. 3 shows an example touch-sensitive apparatus 301 for the purposes of explaining the issues associated with a mutual capacitance measurement technique described above. The touch-sensitive apparatus 300 includes X-direction electrodes 301, Y-direction electrodes 302, an insulating substrate 303 on which the Y electrodes 302 are arranged on one side and the X-direction electrodes are arranged on the other side, connectors 304 which electrically connect the electrodes 301 and 302 to measurement circuitry 305. Other features which are not directly relevant to the example description are omitted for clarity. The electrodes 301, 302, substrate 303, and conductors 304 may be broadly similar to electrodes 101, 102, substrate 103 and conductors 104 described in conjunction with FIG. 1 above, and a specific description of these features is omitted here.

In order to aid explanation, each of the eight electrodes 301 and 302 shown is given an identifier. The four electrodes 301 (those that extend spatially in the X direction) are given the identifiers 1 to 4, while the four electrodes 302 (those that extend spatially in the Y direction) are given the identifiers A to D. The electrodes 301 and 302 in this implementation are orthogonal to one another and spatially intersect at various locations in the X-Y plane (although do not intersect in the Z axis), and these points are herein referred to as intersection points (or sensor nodes). The various intersection points are denoted according to combinations of the identifiers of the corresponding electrodes 301 and 302. For example, the intersection of electrode A and electrode 1 is denoted as intersection point A1, the intersection of electrode B and electrode 2 is denoted as intersection point B2, etc. It should be understood that each of the intersection points corresponds to a position in the X-Y plane of the touch-sensitive element. In other words, the intersection points can be translated into two-dimensional Cartesian coordinates on the surface of the touch-sensitive element.

In accordance with the mutual capacitance measurement technique, each of the drive electrodes 301 is driven, sequentially, with a drive signal. In other words, when considering an example of four drive electrodes 301 as in FIG. 3, the measurement circuitry 305 applies a drive signal to electrode 1 for a first time period, then to electrode 2 for a second time period once the first time period has elapsed, then to electrode 3 for a third time period once the second time period has elapsed, and finally to electrode 4 for a fourth time period once the third time period has elapsed. The first, second, third and fourth time periods are of the same duration, T. When the measurement circuitry 305 is applying the drive signal to one of the electrodes 301, during that time period the measurement circuitry 305 may sequentially couple each receive electrode 302 in turn such that the electric field generated by the transmit electrode is coupled to the measurement circuitry 305. At this time, the measurement circuitry 305 obtains a measurement indicative of the mutual capacitance at each intersection point. For example, when the electrode 1 is driven by the drive signal, the measurement circuitry sequentially couples electrode A for a fifth time period, then electrode B for a sixth time period, then electrode C for a seventh time period, and finally electrode D for an eighth time period. The fifth, sixth, seventh and eighth time periods are of the same duration and in this instance are T/4, such that the sum of the fifth, sixth, seventh and eighth time periods is equal to the time duration T. Accordingly, the measurement circuitry 305 obtains values indicative of the mutual capacitance at the intersection points A1, B1, C1, and D1 respectively. The measurement circuitry 305, after time T has elapsed, applies the drive signal to the next electrode of the transmit electrodes, i.e., electrode 2, and sequentially couples the receive electrodes A to D as described above to obtain values indicative of the mutual capacitance at intersection points A2, B2, C2, and D2. This is repeated for all drive electrodes. (It should be appreciated this processed may be reversed; that is, each transmit electrode 1 to 4 is sequentially supplied with a signal for a time period of T/4 while one receive electrode is coupled to the measurement circuitry 305.)

In practice, the above technique for obtaining an indication of the mutual capacitance is improved by simultaneously coupling a plurality of receive electrodes 302 to the measurement circuitry 305. In this regard, the measurement circuitry 305 may comprise a number of channels, each channel having suitable circuitry for receiving the signal from a receive electrode 302. Accordingly, rather than coupling individual receive electrodes 302 to the measurement circuitry 305 for discrete time periods (i.e., the fifth, sixth, etc. time periods) while one drive electrode 301 is being driven, a plurality of receive electrodes 305 can be coupled to the measurement circuitry 305 while a drive electrode 301 is being driven. For example, if two receive electrodes (e.g., receive electrodes A and B) are coupled to two separate channels of the measurement circuitry 305, then when drive electrode 1 is being driven, the measurement circuitry 305 may obtain an indication of mutual capacitance at intersection points 1A and 1B simultaneously in the fifth time period, before obtaining an indication of mutual capacitance at intersections points 1C and 1D during a sixth time period when receive electrodes C and D are coupled to the measurement circuitry 305. In this case the seventh and eighth time periods are not required. In this instance, either the first time period can be reduced from T to T/2 with each of the fifth and sixth time periods remaining at T/4 (which may subsequently improve the responsiveness of the touch-sensitive apparatus), or the first time period remains at T with each of the fifth and sixth time periods increasing from T/4 to T/2 (which may subsequently improve the signal to noise ratio of the touch-sensitive apparatus). It should be appreciated that some compromise between the two may also be reached.

For the sake of completeness, it should be noted that the measurement circuitry 305 may use a multiplexer to selectively apply the drive signal to the transmit electrodes 301, and/or a multiplexer to selectively connect the receive electrodes 302 to the measurement circuitry 305. This allows a single drive circuitry and single receive circuitry to be used to make all the measurements, thus decreasing the overall costs of the circuitry. However, in other arrangements, each drive electrode may be coupled to its own drive circuitry which is selectively operated, and each receive electrode may be coupled to its own receive circuitry which is selectively operated. It should be appreciated that a combination of the two approaches may also be used, for example the drive electrodes may be coupled to a multiplexer and driven sequentially, while the receive electrodes are individually coupled to corresponding receive circuitry.

For the purposes of comparison later, we will assume the scenario that all receive electrodes 302 are coupled to the measurement circuitry 305 (that is to say, the number of channels of the measurement circuitry 305 is at least equal to the number of receive electrodes 302), and that each drive electrode 301 is driven by a signal for a time period T. Accordingly, the indications of the mutual capacitance for any given drive electrode and any given receive electrode are obtained over a time period of T, while the time required to perform a full scan of the electrode array (i.e., for each of the drive electrodes is T multiplied by the number of drive electrodes, which in the case of FIG. 3 is 4T). Referring back to FIG. 3, if a touch is present at any intersection point, then the mutual capacitance for that intersection point differs from a steady state mutual capacitance, and this can be detected by any suitable processing circuitry (e.g., by comparing the difference between a steady state signal and a measured signal against a predefined threshold). In some practical systems, during the period T when any of the mutual capacitances of the intersection points are being measured by measurement circuitry 305, measurement circuitry 305 is actually sampling the signal a plurality of times and determining an average value of the measurement for that time period. In cases where the time period is short, noise has more of an influence on the calculated mean value of the sampled signal, as compared to when the time period is longer. Therefore, effectively, the predetermined threshold can be set lower in instances where there is more confidence in the calculated mean value being an actual representation of the signal (in other words, when the signal to noise ratio is higher). In instances where there is less confidence in the calculated mean value being an actual representation of the signal (when the signal to noise ratio is lower), then the threshold may be set relatively higher to avoid instances of noise being determined as touches. In other words, the sensitivity of the touch sensitive apparatus can be improved when the signal to noise ratio is relatively high. For a fixed sampling rate, the signal to noise ratio generally varies as the square root of N, where N is the number of samples of the signal. Assuming that the sampling rate is fixed, then the signal to noise ratio effectively also varies as the square root of time, or using the terminology above, T.

While one can consider increasing T to improve signal to noise ratio (and thus sensitivity to a genuine touch), the overall time required to complete a scan of all intersection points also increases with T. In the example described, the overall time required to complete a scan is 4T. This means that the time between placing a finger or the like on the touch-sensitive element to the touch sensitive apparatus detecting the presence of the touch is around 4T. Hence, and as described above, increasing T leads to a detrimental effect on the responsiveness of the touch sensitive apparatus, and therefore a balance between sensitivity and responsiveness is required to be struck.

In addition, one can also use an indication of noise on the measured mutual capacitances to influence sensitivity. For example, the mutual capacitance at any of the intersection points, e.g., the intersection point A1, is a combination of the capacitive coupling between the drive electrode 1 and the receive electrode A resulting from the drive signal applied to the drive electrode 1 and the capacitive coupling between any source(s) of noise and the drive/receive electrode. In this regard, the proportion of the measured mutual capacitance that actually results from the drive signal is lower due to the presence of noise (and in some instances, the noise may be the dominant component). Accounting for this noise before processing the measured mutual capacitance (e.g., by comparing the difference between the measured mutual capacitance and a steady state capacitance) may mean a more dynamic threshold can be set, thereby taking into account whether the measurement was made in low noise conditions (in which case the threshold may be set lower) or high noise conditions (in which case the threshold may be set higher). In other instances, measurements which are made during high noise conditions may be disregarded. (Additionally, it should also be noted that the steady state capacitances which may be obtained in advance are, preferentially, obtained without any noise and/or low noise environments. This is because sources of noise may not necessarily be constant throughout the lifetime of the touch-sensitive apparatus, and thus obtaining the steady state of the mutual capacitance at each intersection point without any noise or in low noise environments leads to greater accuracy and reliability when detecting touches).

In order to obtain an indication of the noise that affects the mutual capacitances at each intersection point, one can measure signals at the receiver electrodes A to D of the electrode array in the absence of any drive signals being applied to the transmit electrodes 1 to 4. For example, measurements indicative of the noise influencing the sixteen intersection points 1A, 1B . . . 4C, 4D) may be obtained by coupling the receiver electrodes A to D to the measurement circuitry 305, coupling the drive electrodes A to D to ground or a constant potential, and measuring the received signal for a period of time (which may be equal to T or different thereto, although in practice it is advantageous to measure the noise for the same duration, or longer, than the duration used to measure the mutual capacitance for each of the intersection points).

Once the signals have been obtained, an indication of the noise may be obtained by summing the four separate signals from each of the receive electrodes A to D and dividing by sixteen (noting that for each signal on the receive electrode, this is the sum of contributions from each of the four drive electrodes). This is therefore indicative of the noise affecting each of the intersection points in the electrode array.

The total time required to determine the indication of the noise, may be around T as noted above.

Accordingly, it should be appreciated that while obtaining an indication of the noise that affects the electrode array may help improve sensitivity and/or improve confidence in the obtained measurements, obtaining the various measurements decreases the responsiveness of the touch-sensitive apparatus to a touch. Indeed, taking the above example, the responsiveness to a touch increases from a time 4T to approximately 5T.

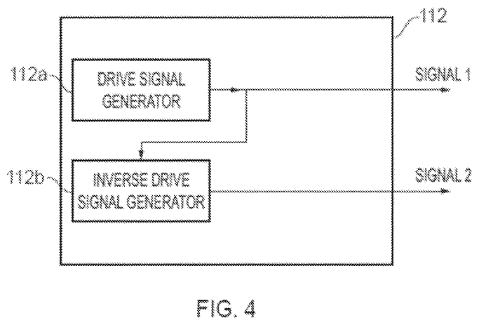

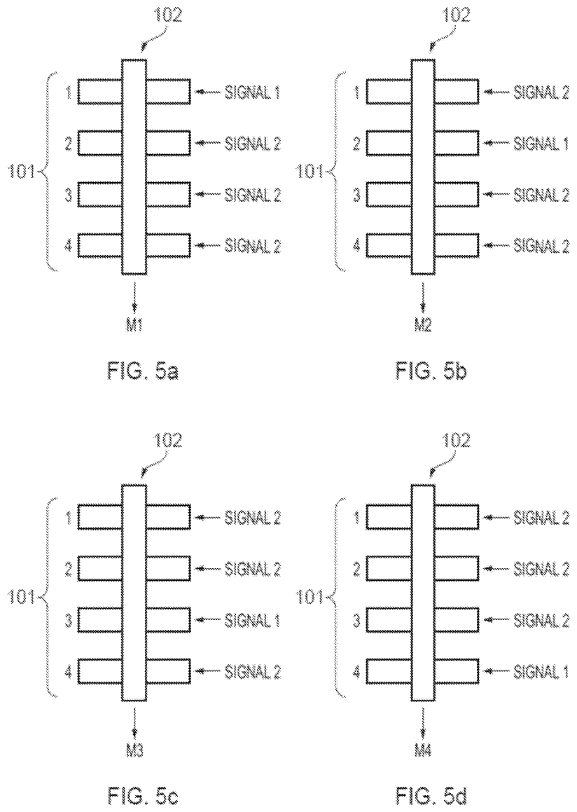

In respect of the example shown in FIG. 3, each drive electrode 301 is driven sequentially with a time-varying signal (such as a time-varying voltage signal). Each drive electrode 301 of the electrode array is typically driven with the same time-varying voltage signal and, as such, each drive electrode is driven separately from the other drive electrodes. However, techniques are also known in which a more efficient use of the mutual capacitance measurement technique to improve the characteristics (i.e., sensitivity and/or responsiveness) of the touch-sensitive apparatus 1 for a given sample rate are implemented. Namely, this is performed by driving multiple drive electrodes using different drive signals. This will be explained with reference to FIGS. 4 and 5 below.

FIG. 4 is a highly schematic representation of the drive circuitry 112 of FIG. 1 in more detail. The drive circuitry 112 comprises a drive signal generator 112a and an inverse drive signal generator 112b. The drive signal generator 112a is configured to generate a first time-varying voltage signal, and more specifically a sine wave voltage signal. For convenience, this is referred to as signal 1. Signal 1 varies sinusoidally in accordance with a certain frequency, w, and having a certain amplitude, A. In other words, signal 1 may be represented mathematically as:

$$signal 1 = + A sin ( ω t ) \qquad ( 1 )$$

As shown in FIG. 4, signal 1 is input into inverse drive signal generator 112b. The inverse drive signal generator 112b is configured to invert signal 1 to produce a second signal, signal 2. In this instance, signal 2 is the inverse of signal 1. That is, signal 2 is a time-varying sine wave voltage signal which varies sinusoidally in accordance with the frequency, ω, and has an amplitude, A, but is 180° out of phase with signal 1. In other words, when signal 1 is positive, signal 2 is negative by an equal but opposite amount. Signal 2 may be represented mathematically as:

$$signal 2 = - A sin ( ω t ) \qquad ( 2 )$$

More generally, however, signal 1 and signal 2 are orthogonal to one another; that is to say, the drive signal generator 112 is configured to provide a plurality of suitable drive signals, each orthogonal to one another, which are capable of being applied to the drive electrodes 101 of the electrode array.

The inverse drive signal generator 112b may be implemented using any suitable circuitry capable of inverting an input signal. Additionally, while the present implementation shows the inverse drive signal generator 112b receiving signal 1, in other implementations the inverse drive signal generator 112b may comprise similar circuitry to drive signal generator 112a but is controlled to generate an inverse signal to signal 1.

In accordance with the described implementation of FIG. 1, the measurement circuitry 105, which comprises drive circuitry 112, outputs signal 1 and/or signal 2 to the drive electrodes 101. More specifically, the measurement circuitry 105 is configured drive ones of the drive electrodes 101 using signal 1 and signal 2. FIGS. 5a to 5d exemplify such scenarios schematically using representations of the electrodes 101 and 102 of FIG. 1. Other features of FIG. 1 are omitted for reasons of clarity. More specifically, FIGS. 5a to 5d illustrate four driven electrodes 101 and a single receive electrode 102. For facilitating explanation, each of the driven electrodes has an identifier 1 to 4 (similar to as described in relation to FIG. 3).

Thus, the measurement circuitry 105 is configured to apply signal 1 and signal 2 to a group of four transmit electrodes 101. Initially, the measurement circuitry 105 applies signal 1 to a first transmit electrode (electrode 1) and signal 2 to the second to fourth electrodes (electrodes 2 to 4), as shown in FIG. 5a. The signals 1 and 2 are applied for a certain time period, e.g., T/4, and during this time, the measurement circuitry 105 makes a measurement M1 using receive electrode 102. The measurement M1 is effectively a summation of each of the signals received from the intersection points of the four electrodes with the receive electrode.

After the time T/4 has elapsed, the measurement circuitry 105 is then configured to apply signal 1 to the second transmit electrode (electrode 2) and signal 2 to the first, third and fourth electrodes (electrodes 1, 2, and 3), as shown in FIG. 5b. The signals 1 and 2 are again applied for a certain time period, e.g., T/4, and during this time, the measurement circuitry 105 makes a measurement M2 using receive electrode 102. As above, in the absence of a touch, M2 is effectively a summation of the signals from the four intersection points. The process is repeated where signal 1 is applied to electrode 3 and then electrode 4, while signal 2 is applied to the remaining electrodes, and measurements M3 and M4 are made using receive electrode, as shown in FIGS. 5c and 5d respectively.

The measurement circuitry 105 outputs measurements M1 to M4 to the processing circuitry 106. The processing circuitry 106 is configured to determine the mutual capacitance for each of the intersection points between electrodes 1 to 4 and receiver electrode 102. In particular, for the receiver electrode 102, processing circuitry 106 is configured to determine the mutual capacitances for the intersection points for electrodes 1 to 4 with receiver electrode 102 using the following equations:

$${E}_{102 - 1} = M 1 - M 2 - M 3 - M 4 \qquad ( 3 )$$

$${E}_{102 - 2} = M 2 - M 1 - M 3 - M 4 \qquad ( 4 )$$

$${E}_{102 - 3} = M 3 - M 1 - M 2 - M 4 \qquad ( 5 )$$

$${E}_{102 - 4} = M 4 - M 1 - M 2 - M 3 \qquad ( 6 )$$

where E₁₀₂₋ₙ is the measured mutual capacitance for the intersection point between electrode 102 and electrode n of the drive electrodes 101.

When a drive signal is applied to a transmit electrode, as mentioned previously, an electric field is generated which couples to the receive electrode(s). The magnitude of the receive signal (i.e., the signal on the receive electrode) is proportional to the magnitude of the drive signal (i.e., the signal applied to the drive electrode). If the magnitude of the drive signal is represented by |A|, the magnitude of the receive signal can be represented by |B|. Additionally, a noise component, Nn, may also couple to each of the electrodes/intersection points from any sources of noise that the touch sensitive apparatus 1 may be exposed to. That is to say, at each intersection point, not only does the drive signal capacitively couple to the receiver electrode, but also any noise couples to either the drive or receive electrode. The noise component is represented as Nn to signify that the noise component may be different at each intersection point (for example, certain electrodes may couple differently based on their proximity to the noise source). Each measurement M1 to M4 is therefore effectively a summation of the corresponding coupled drive signal and any noise components as detected by the receiving electrode. Assuming that both signal 1 and signal 2 when applied to a given transmit electrode couple to the receive electrode in the same way, then measurements M1 to M4 can be mathematically represented as:

$$M 1 = + B 1 sin ( ω t ) + N 1 + - B 2 sin ( ω t ) + N 2 + - B 3 sin ( ω t ) + N 3 + - B 4 sin ( ω t ) + N 4 \qquad ( 7 )$$

$$M 2 = - B 1 sin ( ω t ) + N 1 ++ B 2 sin ( ω t ) + N 2 + - B 3 sin ( ω t ) + N 3 + - B 4 sin ( ω t ) + N 4 \qquad ( 8 )$$

$$M 3 = - B 1 sin ( ω t ) + N 1 + - B 2 sin ( ω t ) + N2 ++ B 3 sin ( ω t ) + N 3 + - B 4 sin ( ω t ) + N 4 \qquad ( 9 )$$

$$M 4 = - B 1 sin ( ω t ) + N 1 + - B 2 sin ( ω t ) + N 2 + - B 3 sin ( ω t ) + N3 ++ B 4 sin ( ω t ) + N 4 \qquad ( 10 )$$

where Bn signifies the amplitude of the coupled signal as received at the receive electrode 102 from drive electrode n, and Nn signifies the noise component at each intersection point. Note that the noise component Nn may be a function of time—that is to say, the noise component Nn obtained in the first time period may not be the same as noise Nn in the second time period. For simplicity, we will assume the noise Nn is constant, however. In the absence of a touch, and assuming that the coupling between each transmit electrode and receive electrode is the same (that is, electrode 1 couples signals 1 and 2 to the receive electrode by the same amount as electrode 2 couples signals 1 and 2, etc.), then B1, B2, B3, and B4 are all equal (for convenience we shall refer to this as B), and effectively each measurement M1, M2, M3 and M4 is equal to −2B sin(ωt) plus any noise components. More particularly, if one considers the noise, then under the above conditions, each measurement M1, M2, M3 and M4 may be represented as −2B sin(ωt)−2N1−2N2−2N3−2N4. Accordingly, under these assumptions, using equations (3) to (6), the signal indicative of the mutual capacitance at each of the intersection points E₁₀₂₋₁, E₁₀₂₋₂, E₁₀₂₋₃, and E₁₀₂₋₄, is equal to 4B sin(ωt)−8N1−8N2−8N3−8N4. This is a value indicative of the mutual capacitance at the intersection point between the receive electrode 102 and each of the transmit electrodes 1 to 4, and in the absence of any touch, may be referred to as indicative of the steady state of the mutual capacitance at the respective intersection point including noise.

As discussed above, a more accurate (or rather noise invariant) steady state of the mutual capacitance at each of the intersection points can be obtained by removing or reducing the effect of noise at each of the intersection points. This may be done as described above; namely measuring the mutual capacitance at each of the intersection points in the absence of drive signals 1 and 2 applied to any of the transmit electrodes 1 to 4.

When a touch is present on the electrodes, say at the intersection point between electrode 1 and the receive electrode 102, then the coupling of the drive signal 1 or 2 to the receive electrode is changed (and in particular lowered). In other words, B1 is no longer equal to B. Using equations (3) to (6), and assuming that B2, B3, and B4 are all equal to B in equations (7) to (10), then the values for the intersection points read as:

$${E}_{102 - 1} = 4 B 1 sin ( ω t ) - 8 N 1 - 8 N 2 - 8 N 3 - 8 N 4 \qquad ( 11 )$$

$${E}_{1 \; 02 - 2} = 4 B sin ( ω t ) - 8 N 1 - 8 N 2 - 8 N 3 - 8 N 4 \qquad ( 12 )$$

$${E}_{1 \; 02 - 3} = 4 B sin ( ω t ) - 8 N 1 - 8 N 2 - 8 N 3 - 8 N 4 \qquad ( 13 )$$

$${E}_{1 \; 02 - 4} = 4 B sin ( ω t ) - 8 N 1 - 8 N 2 - 8 N 3 - 8 N 4 \qquad ( 14 )$$

Hence, according to the present disclosure, the processing circuitry 106 is configured to combine the measurements M1 to M4 to arrive at measurements indicative of the mutual capacitances at each of the intersection points, including a measure of the noise. However, what is significant here is that, although each measurement M1 to M4 takes a time period of T/4 to make the measurement, data regarding each intersection point for a given receive electrode is obtained in each of the measurements M1 to M4. What this means is that data for each intersection point is actually obtained over the time period T (i.e., four times T/4 corresponding to the four measurements M1 to M4). Thus, effectively the number of samples for a particular intersection point is increased by four in this example. As mentioned, the signal to noise ratio is dependent, in part, upon the square root of the number of samples (or the duration over which the measurements are sampled), and thus the processing circuitry 106 is able to provide a roughly double signal to noise ratio for a given signal as compared to the conventional mutual capacitance techniques described in FIG. 3.

As mentioned in relation to FIG. 3, a balance must be struck between sensitivity and responsiveness to a touch. For a four by four grid using the mutual capacitance technique as described in FIG. 3, the total scan time (and thus an indicator of responsiveness) is 4T, while the sample time for each intersection point is T. However, for a four by four grid of electrodes using the technique described in relation to FIG. 5, the total scan time is T (assuming a total time of T is required for each receive electrode 102) but the sample time for each intersection point is increased to T because each measurement M1 to M4 contributes to T/4 worth of samples of the signal at the intersection point. Thus, assuming a constant sample rate, the responsiveness of the touch sensitive apparatus 1 can be improved in accordance with the techniques of FIG. 5 while maintaining the sensitivity. Alternatively, in accordance with the techniques of FIG. 5, the time for each measurement M1 to M4 can be lengthened to T, thus meaning that each intersection point is sampled over an equivalent period of 4T (which provides an improved signal to noise ratio, and thus sensitivity, but a similar responsiveness compared to the conventional example of FIG. 3). Thus, the sensitivity of the touch sensitive apparatus 1 can be improved while maintaining a similar responsiveness. It should be appreciated that both sensitivity and responsiveness may be improved by setting the value for each measurement M1 to M4 between T and T/4.

Hence, by comparing the derived measurement of the mutual capacitance at each intersection point to a threshold value, it can be determined by the processing circuitry 106 at which intersection points on the touch sensitive element a touch 109 is present. For example, the processing circuitry 106 is configured to determine a change in mutual capacitance by calculating the difference between the measured value of the mutual capacitance at an intersection point and a baseline value of the mutual capacitance for the intersection point in the absence of a touch obtained in advance. That is, the processing circuitry may subtract the value of E₁₀₂₋₁ obtained in equation (11) (or an average thereof) from the value of E₁₀₂₋₁ obtained in the absence of a touch (or an average thereof) and compare the difference to a predefined threshold. If the difference is greater than the predefined threshold, then the processing circuitry 106 may output a signal indicating the presence of a touch on the touch sensitive element. The output signal may either be an indication that a touch is detected, or it may include the location (e.g., X-Y coordinates) of the detected touch on the touch sensitive element. In some instances, the signal may include multiple locations corresponding to multiple detected touches.

In respect of the noise, it should be understood that, similarly to the process described with respect to FIG. 3, measuring the signals from the receive electrodes in the absence of a drive signal applied to each of the drive electrodes 1 to 4 (that is, the drive electrodes 1 to 4 are coupled to ground or a constant potential) can provide an indication of the noise. More particularly, using the above notations and under the same assumptions, coupling each drive electrode 1 to 4 to ground or a constant potential, the signal on the receive electrode may be equal to 4N1+4N2+4N3+4N4 plus a constant component resulting from the ground or constant potential, where the measurement is performed over a period of T for consistency with above. Accordingly, dividing by sixteen yields the result (N1+N2+N3+N4)/4 plus a constant, or put another way, an indication of the average level of noise affecting each of the intersection points 102-1, 102-2, 102-3 and 102-4.

It should also be understood that the abovementioned technique can be applied in situations where there are more than four drive electrodes. For instance, when there are eight drive electrodes, a group of four drive electrodes may be driven using the patterns of signals according to FIGS. 5a to 5d, to obtain measurements M1 to M4, followed by driving a second group of electrodes (the remaining drive electrodes 5 to 8) to obtain measurements M5 to M8. This can be extended to electrode arrays comprising any number of drive electrodes. Indeed, even in the case where the number of drive electrodes cannot be grouped into a whole number of groups of four electrodes, e.g., when there are seven drive electrodes, the techniques described above can still be applied; however, in such a case, the measurement circuitry may include certain drive electrodes in multiple groups of electrodes (that is, for example, electrodes 1 to 4 may be driven as the first group of four electrodes, and electrodes 4 to 7 may be driven as the second group of four electrodes). In this case, two measurements would be made for the intersection point E₁₀₂₋₄, although one of these measurements may be disregarded.

In addition, it should be understood that the process described above is repeated, either sequentially or in parallel (or a combination thereof for different groups of receive electrodes), for each receive electrode that is included in the electrode array. That is, for example, measurements of the mutual capacitance are made for each intersection of the drive electrodes of the electrode array with a first receiver electrode simultaneously or sequentially with measurements of the mutual capacitance for each intersection of the drive electrodes of the electrode array with a second receiver electrode, etc.

It should be understood that the above has described the aforementioned sensing technique in respect of groups of four drive electrodes, electrodes 1 to 4. However, the technique can be applied to groups of transmit electrodes comprising different numbers of transmit electrodes, e.g., 2, 4, 8, 12, 16, 20, 24, 28, 32, etc. Suitable adaptation of the equations (3) to (14) can be made to account for the different numbers of electrodes in each the group applying the teachings above.

Overall, it should be understood that applying signals 1 and 2 to groups of drive electrodes as described with respect to FIGS. 4 and 5 may improve the responsiveness and/or sensitivity of the touch-sensitive apparatus 1 as compared to the conventional technique described in relation to FIG. 3.

However, the aforementioned techniques described in respect of FIGS. 3 and 5 still require a separate measure of the indication of noise, if the sensitivity is to be further improved. Because such a separate measurement requires additional time, the responsiveness of the touch sensitive apparatus 1 relatively decreases (under similar conditions). For example, taking the examples of FIGS. 3 and 5 (of four drive electrodes and one receive electrode), using the conventional technique of FIG. 3, the time required to perform a complete scan of the electrodes is 4T (where each intersection point is measured for a time of T). Conversely, using the technique of FIG. 5 and achieving the same sensitivity, the time to perform a complete scan of the electrodes is T. In order to obtain an indication of the noise at each intersection point, regardless of whether using the technique described in FIG. 3 or FIG. 5, with approximately the same sensitivity as the mutual capacitance measurements, a time of T is additionally required (to measure each intersection point for a duration of T in the absence of any drive signals applied to the drive electrodes).

Additionally, it should also be realised that the separate noise measurement in both the technique described in relation to FIG. 3 and in relation to FIG. 5 is performed some time after the measure of the mutual capacitance at the various intersection points is performed; for example, after the measurements M1 to M4 have been made. Any source of noise (and thus any noise component in the measure mutual capacitance) may not necessarily be constant with time and may be subject to variation with time. Accordingly, even though a separate noise measurement may be obtained after e.g., performing the measurements M1 to M4 when using the technique of FIG. 5, there is no guarantee that the separate noise measurement is representative of the actual noise present at the time of performing the measurements M1 to M4.

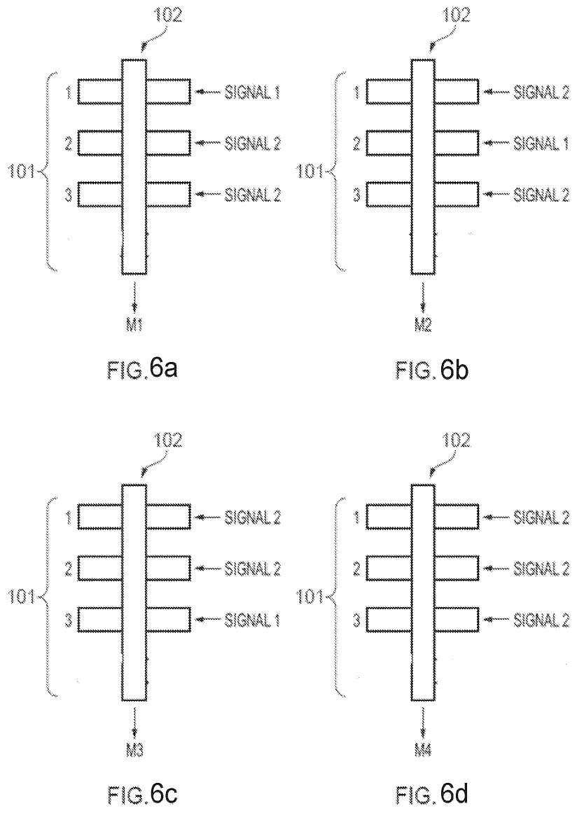

The present inventors have identified techniques which aim to address the abovementioned problems. This will be explained below with reference to FIGS. 6a to 6d. FIGS. 6a to 6d schematically exemplify scenarios using representations of the electrodes 101 and 102 of FIG. 1. Other features of FIG. 1 are omitted for reasons of clarity. FIGS. 6a to 6d will be understood from FIGS. 5a to 5d above. However, unlike FIGS. 5a to 5d, FIGS. 6a to 6d illustrate three drive electrodes 101 and a single receive electrode 102. For facilitating explanation, each of the drive electrodes has an identifier 1 to 3.

In accordance with the present disclosure, the measurement circuitry 105 is configured to apply signal 1 and signal 2 to a group of three transmit electrodes 101. However, what is significant with the techniques to be described in respect of FIGS. 6a to 6d is that although there are only three intersection points (102-1, 102-2 and 102-3), the measurement circuitry 105 proceeds to perform four measurements M1 to M4. In other words, the measurement circuitry 105 is configured to operate in a similar manner as described with respect to FIG. 5, with the exception that the measurement circuitry 105 does not apply signal 1 or signal 2 (as the drive signal) to the fourth drive electrode (not shown in FIGS. 6a to 6d).

FIGS. 6a to 6d will now be explained in more detail. Initially, the measurement circuitry 105 applies signal 1 to a first transmit electrode (electrode 1) and signal 2 to the second to third electrodes (electrodes 2 to 3), as shown in FIG. 6a. The signals 1 and 2 are applied for a certain time period, e.g., T/4, and during this time, the measurement circuitry 105 makes a measurement M1 using receive electrode 102. The measurement M1 is effectively a summation of each of the signals (including any noise components) received from the intersection points of the three drive electrodes with the receive electrode 102. It should be appreciated that this scenario is similar to FIG. 5a with the exception that signal 2 is not applied to the fourth (or any other) electrode of the electrode array.

After the time period, e.g., T/4, has elapsed, the measurement circuitry 105 is then configured to apply signal 1 to the second transmit electrode (electrode 2) and signal 2 to the first and third electrodes (electrodes 1 and 3), as shown in FIG. 6b. The signals 1 and 2 are again applied for a certain time period, e.g., T/4, and during this time, the measurement circuitry 105 makes a measurement M2 using receive electrode 102. As above, M2 is effectively a summation of each of the signals (including any noise components) received from the intersection points of the three drive electrodes with the receive electrode 102. It should be appreciated that this scenario is similar to FIG. 5b with the exception that signal 2 is not applied to the fourth (or any other) electrode of the electrode array.

After the time period, e.g., T/4, has elapsed again, the measurement circuitry 105 is then configured to apply signal 1 to the third transmit electrode (electrode 3) and signal 2 to the first and second electrodes (electrodes 1 and 2), as shown in FIG. 6c. The signals 1 and 2 are again applied for a certain time period, e.g., T/4, and during this time, the measurement circuitry 105 makes a measurement M3 using receive electrode 102. As above, M3 is effectively a summation of each of the signals (including any noise components) received from the intersection points of the three drive electrodes with the receive electrode 102. It should be appreciated that this scenario is similar to FIG. 5c with the exception that signal 2 is not applied to the fourth (or any other) electrode of the electrode array.

Finally, after the time period, e.g., T/4 has elapsed, the measurement circuitry 105 is configured to apply signal 2 to the first to third electrodes (electrodes 1 to 3), as shown in FIG. 6d. In this instance, it should be appreciated that each drive electrode of the group (i.e., electrodes 1 to 3) are driven with the same signal (signal 2), whereas no electrode is driven with the signal 1. Signal 2 is again applied for a certain time period, e.g., T/4, and during this time, the measurement circuitry 105 makes a measurement M4 using receive electrode 102. As above, M4 is effectively a summation of each of the signals (including any noise components) received from the intersection points of the three drive electrodes with the receive electrode 102. It should be appreciated that this scenario is similar to FIG. 5d with the exception that signal 1 is not applied to the fourth (or any other) electrode of the electrode array.

For completeness, it should be understood that the when referring to measurements M1 to M4, these may represent measurements that are obtain at a given point within the respective time periods or, particularly when using a time-varying signal, may represent average or cumulative values obtained over the course of the respective time periods. For instance, as mentioned above, it may be appropriate to sample the signal from the receive electrode at a certain sample rate, and the measurements M1 to M4 in this instance may represent an average or cumulative value of the obtained samples across the duration of the time period.

In any event, the measurement circuitry 105 outputs measurements M1 to M4 to the processing circuitry 106. The processing circuitry 106 is configured to determine the mutual capacitance for each of the intersection points between electrodes 1 to 3 and receiver electrode 102. In addition, and unlike with the technique described in respect of FIG. 5, the processing circuitry 106 is configured to determine an indication of the noise present at the time of obtaining the measurements M1 to M4. In particular, for the receiver electrode 102, processing circuitry 106 is configured to determine the mutual capacitances for the intersection points for electrodes 1 to 4 with receiver electrode 102 using the following equations:

$${E}_{102 - 1} = M 1 - M 2 - M 3 - M 4 \qquad ( 15 )$$

$${E}_{102 - 2} = M 2 - M 1 - M 3 - M 4 \qquad ( 16 )$$

$${E}_{102 - 3} = M 3 - M 1 - M 2 - M 4 \qquad ( 17 )$$

$${E}_{N} = M 4 - M 1 - M 2 - M 3 \qquad ( 18 )$$

where E₁₀₂₋ₙ is the mutual capacitance for the intersection point between electrode 102 and electrode n of the drive electrodes 101 (and substantially mirror equations (3) to (6)), and E_{N} is an indication of the noise which affects the drive electrodes 1 to 3 and receive electrode 102.

Broadly speaking, the processing circuitry 106 is configured to determine the indication of the mutual capacitive coupling between each of the drive electrodes and the receive electrode by combining each of the measurements (M1 to M4) obtained from each of the discrete time periods, and equally, the processing circuitry 106 is configured to determine the indication of the noise (E_{N}) for the drive electrodes based on the measurements (M1 to M4) obtained from the receive electrode by combining each of the measurements (M1 to M4) obtained from each of the discrete time periods. It should further be appreciated that the combination of the measurements for obtaining the indication of the noise (E_{N}) is different to the combination of the measurements (M1 to M4) used to determine the indication of the mutual capacitive coupling between the drive electrodes and the receive electrode (and in fact, these combinations are different amongst themselves, as can be seen by equations (15) to (18)).

Using the same approach as described above in relation to FIG. 5, if the magnitude of the drive signal is represented by |A|, the magnitude of the receive signal can be represented by |B|. Assuming that both signal 1 and signal 2 when applied to a given transmit electrode couple to the receive electrode in the same way, and that each measurement is affect by a noise component Nn, then measurements M1 to M4 can be mathematically represented as:

$$M 1 = + B 1 sin ( ω t ) + N 1 + - B 2 sin ( ω t ) + N 2 + - B 3 sin ( ω t ) + N 3 \qquad ( 19 )$$

$$M 2 = - B 1 sin ( ω t ) + N 1 ++ B 2 sin ( ω t ) + N 2 + - B 3 sin ( ω t ) + N 3 \qquad ( 20 )$$

$$M 3 = - B 1 sin ( ω t ) + N 1 + - B 2 sin ( ω t ) + N 2 ++ B 3 sin ( ω t ) + N 3 \qquad ( 21 )$$

$$M 4 = - B 1 sin ( ω t ) + N 1 + - B 2 sin ( ω t ) + N 2 + - B 3 sin ( ω t ) + N 3 \qquad ( 22 )$$

where, as before, Bn signifies the amplitude of the coupled signal as received at the receive electrode 102 from drive electrode n, and Nn signifies the noise component influencing the intersection point between the receive electrode 102 and drive electrode n. Again, the noise Nn may be a function of time, but for simplicity herein we will assume it is constant across the periods T/4.

It should be appreciated that measurements M1 to M4 represented in equations (19) to (22) are similar to measurements M1 to M4 represented in equations (7) to (10), although exclude the signal that would have resulted from the fourth electrode (and as such, each of M1 to M4 comprise three components attributable to each of the three intersection points rather than four components).

Putting equations (19) to (22) into equations (15) to (18) above, it should be appreciated that each of E₁₀₂₋₁ to E₁₀₂₋₃ result in respective equations for the mutual capacitance at each of the intersection points 102-1 to 102-3, including the noise that affects these mutual capacitances. Conversely, the equation for E_{N} provides a resultant signal which does not have any component attributable to the coupling of the drive signal(s) to the receive electrode 102 at the intersection points 102-1 to 102-3, but instead is a signal that is a measure substantially of the isolated noise. More specifically, E_{N} can be expressed as:

$${E}_{N} = - 2 N 1 + - 2 N 2 + - 2 N 3 \qquad ( 23 )$$

The value E_{N} as calculated above can be considered to represent a measure of the cumulative noise attributable to the drive electrodes 1 to 3 and receiver electrode 102. More generally, the value E_{N} can be considered to be an indication of the noise that affects the set of drive electrodes that are currently being driven (in this example, the set of drive electrodes comprises electrodes 1 to 3).

Accordingly, once the processing circuitry 106 has identified the values E₁₀₂₋₁ to E₁₀₂₋₃ and E_{N}, the processing circuitry 106 may use the value E_{N} (or a value based on E_{N}) in one of at least two ways. Either, the processing circuitry 106 may determine that the value of E_{N} is above a certain first threshold, indicative of the noise affecting the measurements M1 to M4 being too great, and may be configured to disregard the values E₁₀₂₋₁ to E₁₀₂₋₃ on the basis of the indication of noise suggesting there is a low confidence in the values E₁₀₂₋₁ to E₁₀₂₋₃ being representative of an actual signal as opposed to noise. Alternatively, the processing circuitry 106 may use the value of E_{N} to determine the sensitivity threshold to be used to assess whether any of E₁₀₂₋₁ to E₁₀₂₋₃ indicate that a touch has been detected. The processing circuitry 106 may then compare the mutual capacitance values E₁₀₂₋₁ to E₁₀₂₋₃ for the intersection points to steady state values of the mutual capacitances of each intersection point (obtained in advance and in the absence of a touch or other object). If the values depart from the respective steady state value for a given intersection point by a certain threshold, the processing circuitry 106 is able to determine that a touch has been sensed by the touch-sensitive apparatus 1 at that intersection point and outputs a corresponding signal indicative of such. More particularly, when the value E_{N} is relatively low, the processing circuitry 106 may set the threshold for determining whether the signals E₁₀₂₋₁ to E₁₀₂₋₃ are indicative of a touch to be relatively low (thus offering a higher sensitivity) and vice versa for when the value E_{N} is relatively high.

In this regard, for the example of FIGS. 6a to 6d, it should be understood that the time required to perform a complete scan of the three drive electrodes and a measure of the corresponding noise is T. The above technique only measures three intersection points, compared, for example, to the technique described in respect of FIG. 5 where four drive electrodes and four intersection points are measured in the time period T. By way of comparison, however, one may consider that the technique in FIG. 5 requires ¾ (three-quarters) T to obtain the mutual capacitance of the intersections points 102-1 to 102-3 (although in effect it would not be possible to only operate for ¾ T owing to the fact that all four of measurements M1 to M4 are required, but this is provided just for the purposes of a relative comparison). However, in the case of the example of FIG. 5, the time required to obtain the respective noise measurements at each of the intersection points, at the same sensitivity, is on the order of T. If one were to provide a comparison based on an average time per intersection point for obtaining both the mutual capacitance measurement and the indication of noise, then the total relative time required using the technique of FIG. 5 is 0.5T per intersection point (which is essentially 2T divided by 4), compared to only 0.33T per intersection point using the technique of FIG. 6 (which is essentially T divided by 3).

Thus, it can be seen that there is a reduction in the total time required to obtain both the mutual capacitances at the intersection points and an indication of the noise affecting the intersection points when using the technique as described in FIGS. 6a to 6d. This reduction in total time may lead to an improvement in the overall responsiveness of the touch-sensitive apparatus. Alternatively, as described above, the sensitivity may generally be improved by increasing the time period over which the measurements M1 to M4 are made (e.g., from T to 1.1T) while keeping the responsiveness the same. Again, one can find a balance between responsiveness and sensitivity of the touch-sensitive apparatus 1 to meet a particular application. Utilising the technique of FIGS. 6a to 6d offers the designer of the touch-sensitive apparatus more flexibility with regards to this balance owing to the reduction in total time as described above.

Additionally, it should be appreciated that the indication of noise (E_{N}) obtained using the abovementioned technique is an indication of the noise as actually experienced by the set of drive electrodes and receive electrode when obtaining signals used for determining the mutual capacitances of the intersection points. This is accomplished owing to the fact that each of the measurements M1 to M4 each inherently contain signals which are influenced by the noise, and the present technique is able to obtain a measure of this noise from the measurements M1 to M4. This is not possible using the described known techniques for measuring noise (e.g., as described with respect to FIG. 5), whereby a separate noise measurement is performed after the signals for determining the mutual capacitances at the intersection points are obtained (and thus may not be a true a reflection of the noise that is actually influencing the measurements M1 to M4). What this means is that, using the technique of FIG. 6, there is a greater confidence that any indication of the noise (e.g., E_{N}) is a more accurate representation of the noise actually influencing the mutual capacitances at the intersection points resulting from the coupling of the drive signal to the receive electrode. As mentioned previously, this means that either any threshold for determining whether a touch is present, based on the difference between a steady state mutual capacitance and the mutual capacitance can be set based on the indication of the noise (given, in essence, that there is a greater or lesser confidence in the accuracy of the measurement), or that measurements may be disregarded (and potentially subsequently performed later) if the indication of noise is considered to be too great. Hence, there may be the potential for a slight improvement in the sensitivity of the touch-sensitive apparatus 1 when using the techniques of FIGS. 6a to 6d as compared to FIGS. 5a to 5d, even if the time period for obtaining the signals (i.e., T) remains the same in both instances. Of course, it should be appreciated that the potential for improvement in the sensitivity may additionally or alternatively enable the responsiveness to improve (e.g., by reducing the time period T).

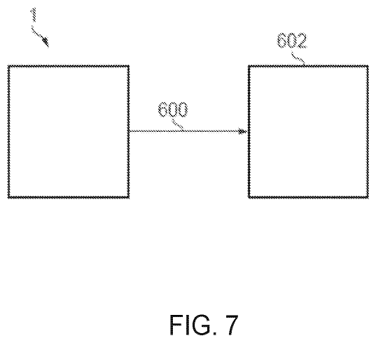

For completeness, we refer now to FIG. 7 which is a highly schematic diagram showing the touch sensitive apparatus 1 coupled to an associated apparatus 602. The associated apparatus 602 generally comprises a computer processor which is capable of running a software application, and may also comprise a display element, such as an LCD screen or the like. In some implementations, the touch sensitive apparatus 1 is integrally formed with the associated apparatus 602, whereas in other implementations the touch sensitive apparatus 1 is able to be coupled to the associated apparatus 602 e.g., via electrical cabling. As described above, in some instances the substrate 103 and cover 108 of the touch sensitive apparatus 1 are transparent and a display element is placed behind the substrate 103 and cover 108, such as in a smartphone.

The touch sensitive apparatus 1 functions as an input mechanism for the associated apparatus 602. As mentioned, the processing circuitry 106 outputs a signal 600 indicating the presence of a touch on the touch-sensitive element to the processing circuitry of the associated apparatus (not shown). In some applications, signal 600 may simply indicate whether or not a genuine touch has been detected on the touch-sensitive element, whereas in other instances, the signal 600 may indicate one or more positions of the touch or touches on the touch-sensitive element, for example as X, Y coordinates (corresponding to the intersection points). The processing circuitry of the associated apparatus 602 may process the signal 600 in accordance with the application being run on the associated apparatus, e.g., by causing the associated apparatus to perform an action or change the image(s) that is displayed on the display unit.

The above description has focused on a specific example where a set of drive electrodes comprises three drive electrodes providing three intersection points with a receive electrode, and wherein four measurements are made by applying four different combinations of the first and second drive signals to the three drive electrodes in four discrete time periods. However, the principles of the present disclosure are not limited to only this scenario.

More generally, any number of drive electrodes may form the set of drive electrodes. Put more broadly, for a group of N drive electrodes, the measurement circuitry 105 performs Y measurements (e.g., M1 to MY) over Y discrete time periods, where Y is greater than N, and N and Y are both integers. For instance, in the above example of FIGS. 6a to 6d, N is equal to three and Y is equal to four. More particularly, Y may take a suitable value selected from the sequence of: 2, 4, 8, 12, 16, 20, 24, 28, 32, etc. (where this sequence has a difference of 4 between each term of the sequence, except for the first number in the sequence, 2). In this regard, it is most efficient if Y takes the next largest value in the sequence relative to the value of N (noting above that Y must be larger than N). This is to reduce any redundant measurements. By way of example, for a group of 9, 10, or 11 drive electrodes (N=9, 10 or 11), Y takes the value of 12. Here, it should be understood that when applying appropriate relationships based on equations (15) to (18), but adapted for the increased number of measurements, there will be several instances of E_{N} being calculated. For instance, when N=11, there will be twelve separate measurements (M1 to M12) and therefor twelve separate equations for the values of “E”, however only eleven of these equations will represent the eleven intersection points, while the remaining five will represent measures of the noise (i.e., E_{N}). To minimise the number of calculations required, and also minimise the time required to make the various measurements, Y may take the next largest value in the sequence. However, the principles of the present disclosure are not limited to Y being the next greatest value in the aforementioned sequence, provided that Y takes any value greater than N from the aforementioned sequence.

What is significant to the principles of the present disclosure is that, when calculating an indication of the noise, i.e., E_{N}, each of the measurements made in the respective discrete time periods, which are also used for calculating an indication of the mutual capacitances of the various intersection points, are also used to calculate an indication of the noise for that set of drive electrodes. That is to say, the processing circuitry is configured to determine an indication of the noise for the set of drive electrodes based on the obtained measurements from the receive electrode in each of the plurality of discrete time periods.

Additionally, it should be appreciated that the technique described above may be applied in the case of a single electrode constituting the set of drive electrodes. In this case, there may not necessarily be any direct improvement in terms of responsiveness of the touch-sensitive apparatus 1, but the indication of the noise is a more accurate measure of the noise that the single drive electrode experiences at the time of making the measurements.

For example, taking the case of a single drive electrode, e.g., electrode 1 of FIG. 6a, and a single receive electrode 102, the measurement circuitry 105 is configured to apply signal 1 to electrode 1 for a first time period, and signal 2 to electrode 1 for a second time period. The mutual capacitance at the intersection points between electrode 1 and receiver electrode 102, E₁₀₂₋₁ and an indication of the noise E_{N} may be obtained as follows:

$${E}_{102 - 1} = M - M 2 \qquad ( 24 )$$

$${E}_{N} = M 1 + M 2 \qquad ( 25 )$$

In this example, the measurements M1 and M2 can be represented as:

$$M 1 = + B 1 sin ( ω t ) + N 1 \qquad ( 26 )$$

$$M 2 = - B 1 sin ( ω t ) + N 1 \qquad ( 27 )$$

Accordingly, the values for E₁₀₂₋₁ and E_{N} can be represented as follows:

$${E}_{102 - 1} = 2 B 1 sin ( ω t ) \qquad ( 28 )$$

$${E}_{N} = 2 N 1 \qquad ( 29 )$$

Similar principles as described above with respect to determining the presence of a touch on the touch sensitive element can be employed in the case of a single transmit electrodes.

Hence, generally, the principles of the present disclosure describe control circuitry configured to: identify a set of drive electrodes comprising at least a drive electrode; apply the drive signals to the set of drive electrodes, wherein the control circuitry is configured to apply the drive signals in a plurality of discrete time periods, wherein, in at least two of the discrete time periods, the control circuitry is configured to apply different a different one of the first drive signal and the second drive signal to the at least a drive electrode of the set of drive electrodes, and wherein the number of electrodes in the set of drive electrodes is less than the number of discrete time periods; obtain a measurement from the receive electrode in each of the plurality of discrete time periods; determine an indication of the mutual capacitive coupling between each of the set of drive electrodes and the receive electrode based on the obtained measurements from the receive electrode in each of the plurality of discrete time periods; and determine an indication of the noise for the set of drive electrodes based on the obtained measurements from the receive electrode in each of the plurality of discrete time periods. More specifically, measurements obtained while driving the set of drive electrodes to provide signals indicative of the mutual capacitance of the intersection points of these drive electrodes with a receive electrode are additionally used to provide an indication of the noise affecting the set of drive electrodes. Essentially, by obtaining information both on the mutual capacitances at the intersection points and the noise simultaneously, advantageously the total time required to scan the electrode array can be decreased (and thus lead to improvements in the sensitivity and/or responsiveness of the touch sensitive apparatus) and a greater confidence in the accuracy of the noise measurement is achieved.

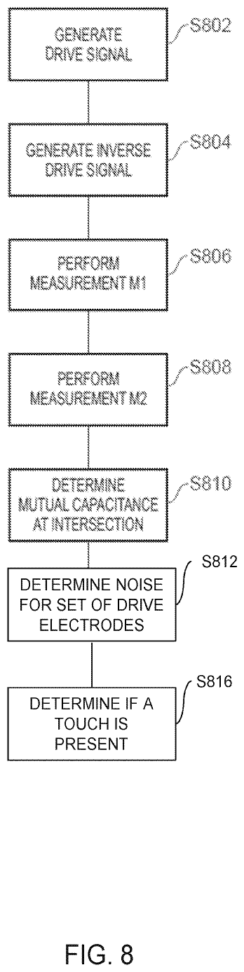

FIG. 8 describes an exemplary method for determining the presence of a touch on a touch sensitive element of a touch sensitive apparatus 1 in accordance with the principles of the present disclosure.

The method begins at step S802 where drive circuitry 112 generates the drive signal (i.e., signal 1). At step S804, the drive circuitry 112 generates the inverse drive signal (i.e., signal 2). Step S804 may utilise the drive signal generated at step S802 as described previously.

At step S806, the method performs measurement M1 on a receive electrode that intersects at least a first drive electrode. This measurement M1 is performed for a first time period. As described previously, at step S806 the measurement circuitry 105 applies at least one of signal 1 or signal 2 to a first drive electrode, and in instances where there are multiple drive electrodes in a set of drive electrodes, the measurement circuitry 105 applies a combination of the first and second drive signals to the multiple drive electrodes (with each drive electrode receiving one or the other of the first and second drive signals). The drive signal(s) (signal 1 and/or signal 2) couple to the receive electrode 102 and measurement circuitry 105 performs measurement M1. The method proceeds then to step S808.

At step S808, the method performs measurement M2 on the same receive electrode. This measurement M2 is performed for a second time period, which in this implementation is of the same duration as the first time period. As described previously, at step S808, in the case of multiple drive electrodes, the measurement circuitry 105 applies a different combination of the first and second drive signals to the multiple drive electrodes (with each drive electrode receiving one or the other of the first and second drive signals), and for a single drive electrode, the measurement circuitry applies the opposite drive signal to the single drive electrode. The drive signal(s) (signal 1 and/or signal 2) couple to the receive electrode 102 from the respective electrode(s), and measurement circuitry 105 performs measurement M2.

Although not shown in FIG. 8, the method may perform further measurements (essentially as described at steps S806 and S808) depending upon the number of drive electrodes included in the set of drive electrodes. That is, for N drive electrodes in the set, the measurement circuitry 105 performs MY measurements, where Y is an integer greater than N and is selected from the sequence 2, 4, 8, 12, 16, etc., as described above.

Once the measurements MY have been obtained, the method proceeds then to step S810 where the processing circuitry 106, using measurements MY, determines a value or signal indicative of the mutual capacitance at each of the intersection points between the drive electrodes of set of drive electrodes and the receive electrode 102. As described above, the processing circuitry may use equations (15) to (17), or variations thereof, depending on the number of drive electrodes in the set of electrodes.

At step S812, using the measurements MY obtained above, the processing circuitry 106 determines a value or signal indicative of the noise experienced by the set of drive electrodes and the receive electrode 102. As described above, the processing circuitry may use equation (18), or variations thereof, depending on the number of drive electrodes in the set of electrodes (and hence the number of measurements MY made).

At this point, the method of FIG. 8 provides sufficient information to the processing circuitry 106 to enable the processing circuitry to determine whether or not a touch (or object) is present at any of the intersection points corresponding to the set of drive electrodes.

At step S816, the method then proceeds to determine whether a touch is detected at any of the intersection points using the mutual capacitances for each of the intersection points of the set of electrodes calculated at step S810. As described previously, this may involve determining a change in the mutual capacitance of the intersection point by comparing the values obtained at step S810 with corresponding values for the respective intersection point(s) obtained in advance and in the absence of a touch. As described above, this may involve the processing circuitry 106 setting a threshold by which the values obtained in step S810 should depart from the corresponding values for the respective intersection point(s) obtained in advance and in the absence of a touch to signify the presence of a touch. As described above, the threshold may be set in accordance with the value obtained at step S812—if the value obtained is relatively large, then the threshold may also be set to be relatively large, whereas if the value obtained is relatively small, then the threshold may also be set to be relatively small. It should be appreciated that the threshold may take any value within a certain range or it may be one of set of discrete values. If the difference/change exceeds the threshold, then the processing circuitry 106 determines that a touch (or other object) is present at the intersection point.

Additionally or alternatively, the processing circuitry 106 may determine that the indication of noise obtained in step S812 signifies a relatively low confidence in the measurements obtained at step S810, and may, in some cases, disregard the measurements obtained at step S812. In this case, the method may involve performing the measurements at step S806 and S808 for the same drive electrodes at a later time (when, for example, the influence of noise on the measurements may be different).

Although FIG. 8 shows the method ending here, it should be appreciated that steps S806 to S816 may be repeated cyclically during operation of the touch sensitive apparatus 1 (for example, on a periodic, i.e., regular, basis). In addition, steps S806 to S812 may be performed individually for a number of sets of drive electrodes (described in more detail below) prior to step S816 being performed (for example, when there is a plurality of drive electrodes in the electrode array greater than the number of drive electrodes in the set of drive electrodes). In some implementations, a measurement value may be obtained for each of the intersection points of an electrode array of drive and receive electrodes prior to step S816 being performed.

It should be appreciated that some touch screens comprise a large number of drive and receive electrodes defining up to hundreds of intersection points on a touch sensitive surface. While the present disclosure has primarily focused on applying drive signals to one set of three electrodes, the plurality of drive electrodes may be divided into a number of sets of three electrodes (or of other numbers of drive electrodes) and the processing circuitry 106 may be configured to sequentially measure each of the sets of drive electrodes in accordance with the described techniques in order to scan the entire electrode array.

Moreover, when dividing the plurality of drive electrodes into groups of electrodes, there may be some drive electrodes which do not comprise the same number of electrodes in the set, e.g., two electrodes. That is to say, the total number of drive electrodes in the electrode array may not be divisible by the number of drive electrodes in the set of drive electrodes (i.e., provides a whole number when the total number of drive electrodes is divided by the number of drive electrodes in the set). However, to compensate for this, two groups can be made to overlap. That is, for example for a total number of drive electrodes that equals five, for a first group, drive electrodes 1 to 3 are included as the three electrodes. Conversely, for a second group, drive electrodes 3 to 5 are included as the three electrodes. However, electrode 3 is included in both groups/sets of drive electrodes in this instance. Thus the processing circuitry 106 is configured to perform measurements M1 to M4 on electrodes 1 to 3, and to subsequently perform measurements M5 to M8 on electrodes 3 to 5. In this instance, the mutual capacitance of the intersection point between electrode 3 and the receive electrode is obtained twice, although the processing circuitry 106 may be configured to disregard one of these measurements.

Further, it should be appreciated that while the drive signal is described as a sinusoidal signal (either signal 1 or signal 2), the principles of the described technique are equally applicable to other signal waveforms for which an inverse waveform of signal 1 can be generated as signal 2, e.g., a square wave, whereby the inverse signal varies in opposition to the initial signal.

In addition, it should be appreciated that the above description focuses on the idea of measuring mutual capacitances from an electrode array, e.g., the capacitance between a first drive electrode and a receive electrode. However, the abovementioned technique can be applied to a system configured to measure the self-capacitance of a given (drive) electrode.

In respect of self-capacitance, drive circuitry (such as drive circuitry 112) is configured to generate and apply a drive signal to a drive electrode (e.g., such as drive electrode 101) which will cause an electric field to form around the drive electrode. This field couples through the space around the electrode back to measurement circuitry (such as measurement circuitry 105) via numerous conductive return paths that are part of the nearby circuitry of the sensor element and the product housing or physical elements from the nearby surroundings etc., so completing a capacitive circuit. The overall sum of return paths is typically referred to as the “free space return path” in an attempt to simplify an otherwise hard-to-visualize electric field distribution. The important point to realise is each electrode is driven from a single explicit electrical terminal; the other terminal is the capacitive connection via this “free space return path”. The capacitance measured by the measurement circuitry is the “self-capacitance” of the sensor electrode (and connected tracks) that is being driven relative to free space (or Earth as it is sometimes called) i.e. the “self-capacitance” of the relevant sensor electrode. Touching or approaching the electrode with a conductive element, such as a human finger, causes some of the field to couple via the finger through the connected body, through free space and back to the measurement circuitry. This extra return path can be relatively strong for large objects (such as the human body), and so can give a stronger coupling of the electrode's field back to the measurement circuitry; touching or approaching the electrode hence increases the self-capacitance of the electrode. The measurement circuitry is configured to sense this increase in capacitance. The increase is strongly proportional to the area of the applied touch and is normally weakly proportional to the touching body's size (the latter typically offering quite a strong coupling and therefore not being the dominant term in the sum of series connected capacitances). Therefore, broadly speaking, a touch-sensitive apparatus configured to measure a self-capacitance of a drive electrode of an electrode array, drives a drive electrode with a drive signal (such as the first drive signal 1 or second drive signal 2) and the measurement circuitry measures a self-capacitance of the drive electrode. This is unlike the mutual capacitance technique discussed above whereby the capacitive coupling that is measured is between the driven electrode and the receive electrode (i.e., another electrode of the electrode array).

It should be appreciated that a touch-sensitive apparatus may be configured to operate in either the self-capacitance or mutual capacitance measurement modes. A touch-sensitive apparatus may be configured to operate exclusively in one of these measurement modes, or have the functionality to switch between measurement modes.

In respect of the present disclosure, the touch-sensitive apparatus 1 may be configured to operate in the self-capacitance mode. The touch sensitive apparatus 1 may be configured as shown in FIG. 1.

When operating in the self-capacitance mode, and in accordance with the principles of the present disclosure, the measurement circuitry 105 is configured to apply e.g., signal 1 to electrode 1 (as the drive electrode) for a first time period, and to apply signal 1 to electrode 1 for a second time period. During these time periods, separate measurements M1, M2 indicative of the self-capacitance are obtained by the measurement circuitry 105. In this regard, it should be appreciated that the separate measurements M1 and M2, despite being driven by the same drive signal, are treated as separate measurements (e.g., measurement M1 may be an average of a plurality of measurements taken in the first time period, while measurement M2 may be an average of a plurality of measurements taken in the second time period).

The self-capacitance of electrode 1, E₁ and an indication of the noise E_{N} may be obtained as follows:

$${E}_{1} = M 1 + M 2 \qquad ( 30 )$$

$${E}_{N} = M 1 - M 2 \qquad ( 31 )$$

In this example, the measurements M1 and M2 can be represented as (noting that the constant A1 is used as there is no coupling to the receive electrode):

$$M 1 = + A 1 sin ( ω t ) + N 1 \qquad ( 32 )$$

$$M 2 = + A 1 sin ( ω t ) + N 2 \qquad ( 33 )$$

Accordingly, the values for E₁ and E_{N} can be represented as follows:

$${E}_{1} = 2 B 1 sin ( ω t ) + N 1 + N 2 \qquad ( 34 )$$

$${E}_{N} = N 1 - N 2 \qquad ( 35 )$$

Similar principles as described above with respect to determining the presence of a touch on the touch sensitive element can be employed (namely, determining whether the value E₁ exceeds a threshold value obtained in advance). Additionally, the indication of noise, E_{N}, can be used to provide a level of confidence in the measurement of E₁, in much the same way as above.

It should also be appreciated that, in the second of the discrete time periods, the second drive signal 2 may instead be applied to the drive electrode.

It should also be appreciated that the principles of the present disclosure may also be extended to groups of N drive electrodes driven with at least a drive signal with the touch-sensitive apparatus operating the self-capacitance mode. In much the same way as described above, measurements of the capacitive coupling can be obtained when driving a plurality of electrodes (e.g., equations (15) to (22), or variants thereof, can be used when a set of 3 electrodes are driven by the various drive signals).

Hence, generally, the principles of the present disclosure describe control circuitry configured to: identify a set of N drive electrodes comprising the at least a drive electrode, where N is an integer greater than or equal to one; apply one or more drive signals to the set of N drive electrodes, wherein the control circuitry is configured to apply the one or more drive signals in a plurality of discrete time periods, wherein the number of electrodes in the set of N drive electrodes is less than the number of discrete time periods. The control circuitry is also configured to obtain a measurement from the electrode array in each of the plurality of discrete time periods; determine an indication of a capacitive coupling the associated with the at least a drive electrode based on the obtained measurements from the receive electrode array in each of the plurality of discrete time periods (where the indication of a capacitive coupling may be the self-capacitance of the drive electrode or the mutual capacitance between the drive electrode(s) and a receive electrode); and determine an indication of the noise for the set of N drive electrodes based on the obtained measurements from the electrode array in each of the plurality of discrete time periods. Essentially, by obtaining information both on the capacitive couplings and the noise simultaneously, advantageously the total time required to scan the electrode array can be decreased (and thus lead to improvements in the sensitivity and/or responsiveness of the touch sensitive apparatus) and a greater confidence in the accuracy of the noise measurement is achieved.

Thus there has been described a touch-sensitive apparatus, the apparatus including an electrode array, comprising at least a drive electrode; drive circuitry configured to generate one or more drive signals comprising at least a first drive signal for driving the at least a drive electrode; and control circuitry. The control circuitry is configured to: identify a set of N drive electrodes comprising the at least a drive electrode, where N is an integer greater than or equal to one; apply the one or more drive signals to the set of N drive electrodes, wherein the control circuitry is configured to apply the one or more drive signals in a plurality of discrete time periods, wherein the number of electrodes in the set of N drive electrodes is less than the number of discrete time periods; obtain a measurement from the electrode array in each of the plurality of discrete time periods; determine an indication of a capacitive coupling associated with the at least a drive electrode based on the obtained measurements from the electrode array in each of the plurality of discrete time periods; and determine an indication of the noise for the set of N drive electrodes based on the obtained measurements from the electrode array in each of the plurality of discrete time periods. Also disclosed is a system including the touch-sensitive apparatus and a method for enabling the presence of a touch on or in the vicinity of a touch-sensitive element of a touch-sensitive apparatus to be determined.

Further particular and preferred aspects of the present invention are set out in the accompanying independent and dependent claims. It will be appreciated that features of the dependent claims may be combined with features of the independent claims in combinations other than those explicitly set out in the claims.

1. A touch-sensitive apparatus, the apparatus comprising:
an electrode array, comprising at least a drive electrode;
drive circuitry configured to generate one or more drive signals comprising at least a first drive signal for driving the at least a drive electrode;
control circuitry configured to:
identify a set of N drive electrodes comprising the at least a drive electrode, where N is an integer greater than or equal to one;
apply the one or more drive signals to the set of N drive electrodes, wherein the control circuitry is configured to apply the one or more drive signals in a plurality of discrete time periods, wherein the number of electrodes in the set of N drive electrodes is less than the number of discrete time periods;
obtain a measurement from the electrode array in each of the plurality of discrete time periods;
determine an indication of a capacitive coupling associated with the at least a drive electrode based on the obtained measurements from the electrode array in each of the plurality of discrete time periods; and
determine an indication of the noise for the set of N drive electrodes based on the obtained measurements from the electrode array in each of the plurality of discrete time periods.

2. The touch-sensitive apparatus of claim 1, wherein:
the electrode array additionally comprises at least one receive electrode;
the one or more drive signals comprises at least a first drive signal and a second drive signal;
the control circuitry is configured to:
apply the one or more drive signals to the set of N drive electrodes in a plurality of discrete time periods, wherein in at least two of the discrete time periods, the control circuitry is configured to apply a different one of the first drive signal and the second drive signal to the at least a drive electrode of the set of drive electrodes;
obtain a measurement from the receive electrode of the electrode array in each of the plurality of discrete time periods;
determine, as an indication of a capacitive coupling associated with the at least a drive electrode, a mutual capacitive coupling between each of the set of N drive electrodes and the receive electrode based on the obtained measurements from the receive electrode of the electrode array in each of the plurality of discrete time periods; and
determine an indication of the noise for the set of N drive electrodes based on the obtained measurements from the receive electrode of the electrode array in each of the plurality of discrete time periods.

3. The touch-sensitive apparatus of claim 2, wherein the control circuitry is configured to:
apply one of the first and second drive signals to the at least a first drive electrode during a first discrete time period;
obtain a first measurement from the receive electrode during the first discrete time period;
apply the other of the first and second drive signals to the at least a first drive electrode during a second discrete time period;
obtain a second measurement from the receive electrode during the second discrete time period;
determine an indication of the mutual capacitive coupling between the at least a drive electrode and the receive electrode based at least on the obtained first and second measurements from the receive electrode; and
determine the indication of the noise for the set of N drive electrodes based at least on the obtained first and second measurements.

4. The touch-sensitive apparatus of claim 1, wherein:
the control circuitry is configured to:
obtain a measurement from at least drive electrode of the electrode array in each of the plurality of discrete time periods;
determine, as an indication of a capacitive coupling associated with the at least a drive electrode, a self-capacitive coupling of the at least drive electrode based on the obtained measurements from the at least drive electrode of the electrode array in each of the plurality of discrete time periods; and
determine an indication of the noise for the set of N drive electrodes based on the obtained measurements from the at least drive electrode of the electrode array in each of the plurality of discrete time periods.

5. The touch-sensitive apparatus of claim 4, wherein the control circuitry is configured to:
apply a first drive signal to the at least a drive electrode during a first discrete time period;
obtain a first measurement from the at least a drive electrode during the first discrete time period;
apply the first drive signal to the at least a drive electrode during a second discrete time period;
obtain a second measurement from the at least a drive electrode during the second discrete time period;
determine an indication of the self-capacitive coupling of the at least a drive electrode based at least on the obtained first and second measurements from the receive electrode; and
determine the indication of the noise for the set of N drive electrodes based at least on the obtained first and second measurements.

6. The touch-sensitive apparatus of claim 1, wherein determining the indication of the capacitive coupling associated with the at least a drive electrode includes combining each of the obtained measurements from each of the plurality of discrete time periods.

7. The touch-sensitive apparatus of claim 1, wherein determining the indication of the noise for the set of N drive electrodes based on the obtained measurements from the electrode array includes combining each of the obtained measurements from each of the plurality of discrete time periods.

8. The touch-sensitive apparatus of claim 7, wherein determining the indication of the capacitive coupling associated with the at least a drive electrode includes combining each of the obtained measurements from each of the plurality of discrete time periods, and wherein the combination of each of the obtained measurements from each of the plurality of discrete time periods for determining the indication of the noise for the set of N drive electrodes is different to the combination of each of the obtained measurements from each of the plurality of discrete time periods for determining the indication of the capacitive coupling associated with the at least drive electrode.

9. The touch-sensitive apparatus of claim 1, wherein, when the set of N drive electrodes comprises N number of drive electrodes, the control circuitry is configured to apply the drive signals over Y number of discrete time periods, wherein Y is greater than N.

10. The touch-sensitive apparatus of claim 9, wherein Y is selected from the sequence of: 2, 4, 8, 12, 16, 20, 24, 28, 32, etc.

11. The touch-sensitive apparatus of claim 10, wherein Y is the next largest value in the sequence from N.

12. The touch-sensitive apparatus of claim 2, wherein the control circuitry is configured to determine combinations of the first and second drive signals to be applied to the set of N drive electrodes, wherein each electrode of the set of N drive electrodes receives one of the first and second drive signals in a given discrete time period, and wherein each one of the determined combinations of the first drive signal and second drive signals is applied in a respective one of the plurality of discrete time periods.

13. The touch-sensitive apparatus of claim 12, wherein each combination of the first drive signal and second drive signal is different from one another.

14. The touch-sensitive apparatus of claim 1, wherein the set of electrodes comprises only one drive electrode.

15. The touch-sensitive apparatus of claim 1, wherein the control circuitry is configured to determine the presence of a touch on the touch-sensitive apparatus by comparing the determined indication of the capacitive coupling associated with the at least a drive electrode to a corresponding indication of the capacitive coupling associated with the at least a drive electrode obtained in advance.

16. The touch-sensitive apparatus of claim 15, wherein determining the presence of a touch on the touch-sensitive apparatus includes determining whether the indication of the capacitive coupling associated with the at least a drive electrode differs from the corresponding indication of the capacitive coupling associated with the at least a drive electrode obtained in advance by a threshold, wherein optionally, the threshold is determined based on the determined indication of the noise for the set of N drive electrodes.

17. (canceled)

18. The touch-sensitive apparatus of claim 1, wherein the control circuitry is configured to disregard the obtained measurement from the electrode array in each of the plurality of discrete time periods if the determined indication of the noise for the set of N drive electrodes indicates the noise exceeds a predetermined upper threshold.

19. A system comprising the touch-sensitive apparatus of claim 1, further comprising system processing circuitry communicatively coupled to the processing circuitry of the touch-sensitive apparatus.

20. The system of claim 19, wherein the system processing circuitry is configured to cause the system to perform a first action in response to receiving a signal output from the processing circuitry of the touch-sensitive apparatus indicating the presence of a touch on the touch-sensitive element.

21. A method for enabling the presence of a touch on or in the vicinity of a touch-sensitive element of a touch-sensitive apparatus to be determined, the touch-sensitive apparatus comprising an electrode array, comprising at least a drive electrode, drive circuitry configured to generate one or more drive signals comprising at least a first drive signal for driving the at least a drive electrode, and control circuitry, wherein the method comprises:
identifying a set of N drive electrodes comprising the at least a drive electrode;
applying the one or more drive signals to the set of N drive electrodes in a plurality of discrete time periods, wherein the number of electrodes in the set of N drive electrodes is less than the number of discrete time periods;
obtaining a measurement from the electrode array in each of the plurality of discrete time periods;
determining an indication of a capacitive coupling associated with the at least a drive electrode based on the obtained measurements from the electrode array in each of the plurality of discrete time periods; and
determining an indication of the noise for the set of N drive electrodes based on the obtained measurements from the electrode array in each of the plurality of discrete time periods.
